(19) United States
(12) Patent Application Publication
(10) Pub. No.: US 2026/0328176 A1
(43) Pub. Date: Oct. 22, 2026

(54) SYSTEMS AND METHODS FOR POWER GENERATION OVERSPEED PROTECTION

(71) Applicant: OneSubsea IP UK Limited, London (GB)

(72) Inventors: Alexander Tuborg Vilstrup, Bergen (NO); Stig Kaare Kanstad, Bergen (NO); Audun Magne Askeland, Aksdal (NO); Bernt Helge Torkildsen, Bergen (NO); Jean Francois Noel, Bergen (NO); Petter Solberg, Sandsli (NO); Lars Rune Kaldestad, Bergen (NO); Annbjoerg Werdal, Nyborg (NO); Jens Haga, Fyllingsdalen (NO)

(21) Appl. No.: 19/186,160

(22) Filed: Apr. 22, 2025

(51) Int. Cl. F03B 15/00; F03B 13/10; H02P 9/00; H02P 101/10

(52) U.S. Cl. CPC F03B 15/00; F03B 13/10; H02P 9/006; F05B 2260/90; F05B 2270/1011; F05B 2270/335; H02P 2101/10

(57) ABSTRACT

A system may include a subsea power generation system including a turbine configured to couple to a flow line, where the turbine is configured to generate mechanical power using flow of a fluid through the turbine, a generator coupled to the turbine, where the generator is configured to apply a load to the turbine based on generating electrical power using the mechanical power from the turbine, and an overspeed protection system configured to reduce or eliminate overspeed of the turbine based on a loss of the load from the generator.

### BACKGROUND

The present disclosure generally relates to systems and methods for reducing or eliminating risk of overspeed for subsea power generation systems. More specifically, the present disclosure relates to a subsea power generation system with overspeed protection to reduce or eliminate risk of turbine overspeed in the event of losing an electrical load.

Depleted offshore oil and gas reservoirs or other subterranean cavities with pressure less than pressure from a hydrostatic column may be used for hydropower generation, by natural seawater flooding through a subsea power generation (SPG) system. The pressure from the hydrostatic column may be based on a differential pressure and drives natural flooding of seawater into a well (e.g., reservoir). Sea water flowing into a well through a turbine of the SPG system, driven by pressure differences between the pressure (e.g., total pressure) of sea water and the pressure (e.g., total pressure) in the well, drives the SPG system to produce electrical power. Such systems may be at risk of overspeed when an electrical load (e.g., speed control load, generator load) is lost. For example, if power is lost (e.g., electrical load is lost), the flow of sea water through the turbine and into the reservoir may rapidly increase, which may cause overspeed of the turbine and/or overspeed related damage to the turbine, the generator, various connector or couplings between the generator and the turbine, or both. Therefore, systems and methods for reducing and/or eliminating risk of overspeed in the event of loss of an electrical load (e.g., system shutdown, power outage, emergency shutdown, or generator failure) may be desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a system may include a subsea power generation system including a turbine configured to couple to a flow line, where the turbine is configured to generate mechanical power using flow of a fluid through the turbine, a generator coupled to the turbine, where the generator is configured to apply a load to the turbine based on generating electrical power using the mechanical power from the turbine, and an overspeed protection system configured to reduce or eliminate overspeed of the turbine based on a loss of the load from the generator.

In an embodiment, a system may include a flow line configured to provide a fluid to a well, where the fluid comprises water from a subsea environment having a water pressure greater than a well pressure in the well and a subsea power generation system coupled to the flow line, where the subsea power generation system is configured to fill the well with the fluid based a pressure differential between the water pressure and the well pressure. The subsea power generation system may include a turbine configured to generate mechanical power based on a flow of the fluid through the turbine, a generator coupled to the turbine, wherein the generator is configured to generate electrical power based on the mechanical power from the turbine, and an overspeed protection system configured to adjust an amount of the fluid provided to the turbine.

In an embodiment, a system may include a subsea power generation system including a turbine configured to generate mechanical power based movement of a fluid through the turbine and an overspeed protection system coupled to the turbine and configured to adjust an amount of fluid provided to the turbine based on a speed of the turbine.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of a subsea power generation (SPG) system for filling one or more subterranean reservoirs and generating electrical power, in accordance with embodiments of the present disclosure;

FIG. 2 is a schematic diagram of a portion of a flow line coupled to the SPG system of FIG. 1 with an embodiment of an overspeed protection system (e.g., a spring-controlled valve) for overspeed protection, in accordance with embodiments of the present disclosure;

FIG. 3 is a schematic diagram of a portion of the flow line coupled to the SPG system of FIG. 1 with another embodiment of the overspeed protection system (e.g., spring-controlled valves) for overspeed protection, in accordance with embodiments of the present disclosure;

FIG. 4 is a schematic diagram of a portion of the flow line coupled to the SPG system of FIG. 1 with another embodiment of the overspeed protection system (e.g., centrifugal brake, guide vane assembly, and brake assembly) for overspeed protection, in accordance with embodiments of the present disclosure;

FIG. 5 is a schematic diagram of a portion of the flow line coupled to the SPG system of FIG. 1 with another embodiment of the overspeed protection system (e.g., a hydraulic disc brake) for overspeed protection, in accordance with embodiments of the present disclosure;

FIG. 6A is a top down cross-sectional view of an inlet of a turbine of the SPG system of FIG. 1 with another embodiment of the overspeed protection system (e.g., flow control valve) in an open position, in accordance with embodiments of the present disclosure;

FIG. 6B is another top down cross-sectional view of embodiment of the overspeed protection system of FIG. 6A in a closed position, in accordance with embodiments of the present disclosure;

FIG. 7A is a schematic diagram of a portion of the flow line coupled to the SPG system with another embodiment of the overspeed protection system (e.g., spring-loaded drag brakes) for overspeed protection, in accordance with embodiments of the present disclosure; and

FIG. 7B is a cross-sectional view of the embodiment of the overspeed protection system of FIG. 7A, in accordance with embodiments of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled) and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

The present disclosure is generally directed towards systems and methods for subsea power generation (SPG) systems that may be driven by pressure differentials. In SPG systems, various types of infrastructure and equipment may be positioned offshore, such as underwater along a sea floor and/or on a surface of the sea to aid in retrieving hydrocarbon fluids. After depleting hydrocarbon fluids from a hydrocarbon well in a subterranean formation, the SPG system may remain along the sea floor and/or on the surface of the sea to fill a depleted hydrocarbon well. For example, sea water may flow into the depleted well through a turbine of the SPG system that may be driven by pressure difference between the pressure of sea water and the pressure in the well. The turbine may be coupled to and/or integrated with a generator, thus generating electrical power while filling the well. However, the turbine may be at risk of overspeed if an electrical load is lost, which may result in damage to the turbine, the generator, connections between the turbine and the generator, or any combination thereof.

Embodiments of the present disclosure are directed to systems and methods for overspeed protection by reducing the differential pressure across the turbine, reducing flowrate into the system, adding a load to the generator, or any combination thereof. In particular, the disclosure herein describes a SPG system with an overspeed protection system configured to reduce and/or eliminate risk of overspeed in in the event of a lost load.

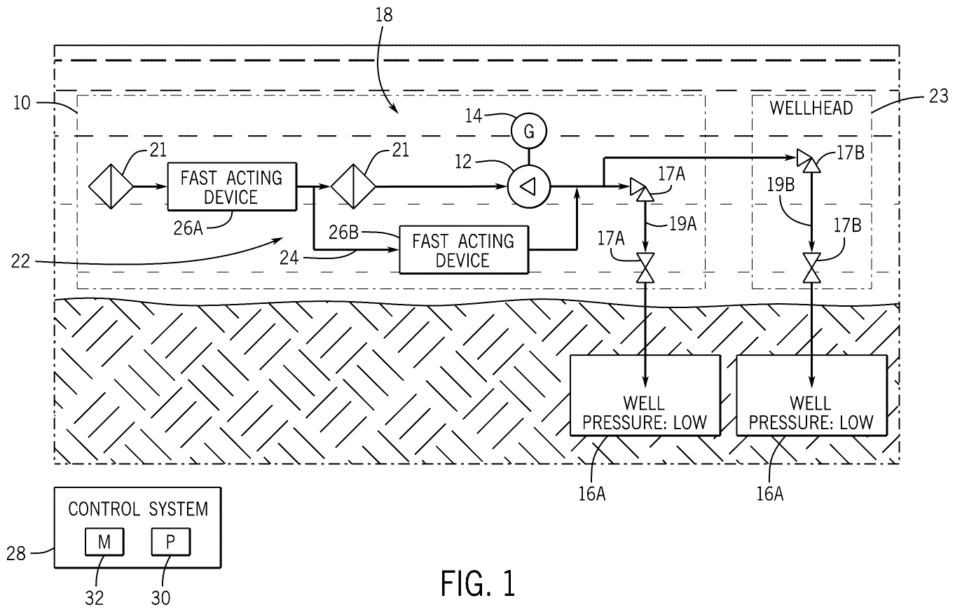

By way of introduction, FIG. 1 is a block diagram a block diagram a subsea power generation (SPG) system 10 configured to fill one or more subterranean reservoirs and generate electrical power. As should be appreciated, the SPG system 10 is provided as an example power generation system. The SPG system 10 may be implemented separately or in conjunction with other subsea and/or land-based production systems. For example, the SPG system 10 may be coupled to other SPG systems 10 to provide and/or receive electrical power to and from other SPG systems 10.

The SPG system 10 may include a generator 14 and a turbine 12 to generate the electrical power. The turbine 12 may be driven by pressure differences between the pressure of sea water and the pressure in a well 16 to generate mechanical power. For example, the turbine 12 may couple to and utilize fluid flow (e.g., sea water movement) along a flow line 18 (e.g., flow path) to generate mechanical power. The turbine 12 may couple to and/or integrate with the generator 14 to convert the mechanical power into electrical power. In some embodiments, the turbine 12, the generator 14, or both may be disposed underwater along a sea floor (e.g., subsea) or on a surface of the sea. The generator 14 may deliver electrical power to offshore actuators, motors, valves, sensors, and various equipment of the SPG system 10, other SPG systems 10, neighboring wells and Christmas trees, and so on. The turbine 12, the generator 14, or both may be coupled to a main power grid, such as at an offshore facility. If the main power grid loses power, the generator 14 and the turbine 12 may experience loss of an electrical load, which may result in overspeed of the generator 14, the turbine 12, or both.

The generator 14 may provide electrical power to drive various flow control equipment (e.g., electric actuator driven valves 17) and boosting equipment (e.g., pumps, compressors, etc.). For example, the generator 14 may provide electrical power to drive a first set of valves 17A along a first input line 19A coupled to the flow line 18 to open (e.g., an open position) to provide fluid flow to a first well 16A and close (e.g., a closed position) to block fluid flow to the first well 16A. Additionally or alternatively, the generator 14 may drive a second set of valves 17B along a second input line 19B to open or close to adjust fluid flow into the second well 16B. As illustrated, the first set of valves 17A and the first input line 19A are positioned within the SPG system 10, and the second set of valves 17B and the second input line 19B are positioned within a wellhead 23 coupled to the SPG system 10. However, it may be understood that the valves 17 and the input lines 19 may be positioned within any suitable location, such as the SPG system 10, the wellhead 23, or both. Additionally or alternatively, the generator 14 may provide power to boosting equipment, reduce the need for a variable speed drive (VSD), reduce losses as the generator 14 and the boosting system may be placed closer than a topside power generator.

The valves 17 (e.g., electric actuator driven valves) may include check valves, isolation valves, flow control valves, gate valves, ball valves, blowout preventers (BOPs), chokes, and the like. The water and chemical injection systems may include valves, pumps, flowmeters, and other flow control equipment. In alternative or additional embodiments, the generator 14 may provide electrical power to drive a variety of sensors or monitoring equipment, such as flow meters, temperature sensors, pressure sensors, water sensors, fluid composition sensors, leak sensors, or any combination thereof. For example, the sensors may be positioned within the turbine 12, within the generator 14, along the flow line 18, and so on. The sensors may generate a sensor signal indicative of a property, such as a speed of the turbine 12, a load outputted by the generator 14, a speed of fluid flow along the flow line 18, a pressure within the flow line 18, and so on. In certain instances, the flow line 18 may include filters 21 to block certain particulates (e.g., minerals, rocks, marine life) from entering the flow line 18 and/or other external equipment subsea and topside installations.

To power the generator 14 and deliver fluids to the wells 16, the turbine 12 may be disposed along, within, or adjacent to the flow line 18 between the well 16 and a lower pressure portion of the SPG system 10. As discussed herein, the turbine 12 may be driven by pressure differences between the static height of sea water and the pressure in the well 16. For example, a plurality of circumferentially spaced blades of the turbine 12 may be positioned within a portion of the flow line 18 that includes a pressure differential and driven to rotate based on the pressure differential. In certain instances, the energy transfer between the flow of seawater and the turbine 12 may be a reaction-type energy transfer, such as energy transferred through change of flow velocity and static pressure across turbine stages. The blades of the turbine 12 may cause the rotation of a connected turbine rotor to generate mechanical power. The generator 14 coupled to the turbine rotor may produce electrical power based on the mechanical power generated. For example, the generator 14 may produce electrical power based on a rate of rotation of the turbine rotor. The generator 14 may use the electrical power to drive components within the SPG system 10, provide the electrical power to power to other SPG systems 10, and/or a power grid, such as a land-based power grid (e.g., municipal infrastructure). In certain embodiments, the turbine 12 may be located in a well 16 (e.g., between the reservoir and the SPG system 10).

In certain instances, the rotational speed or rotational frequency of the turbine 12 (e.g., the turbine rotor) may correspond to an amount of fluid flowing through the flow line 18, a pressure within the flow line 18, a load applied by the generator 14 to the turbine 12, or a combination thereof. For example, the speed and/or frequency of the turbine 12 may increase based on an increase in the amount of fluid entering and/or flowing along the flow line 18 and decrease based on a decrease in the amount of fluid entering and/or flowing along the flow line 18. If fluid flow through the flow line 18 increases, the pressure within the flow line 18 may also increase and cause the speed of the turbine blades and/or the speed of the turbine rotor to increase. In another example, the speed and/or frequency of the turbine 12 may decrease based on an increase in the load applied by the generator 14 when generating the electrical power. The speed and/or frequency of the turbine 12 may be adjusted based on a the load applied by the generator 14. If the electrical load is lost, the pressure downstream of the turbine 12 and the fluid flowing through the flow line 18 may increase, thereby increasing risk of overspeed of the turbine 12, the generator 14, or both. In other words, a reduction in total pressure losses (e.g., based on loss of the electrical load) may increase flow rates and increase risk of overspeed of the turbine 12, the generator 14, or both. Additionally or alternatively, loss of the electrical load may cause pressure surges during a system trip, which may result in wear and/or damage to the turbine 12, the generator 14, the filters 21, the valves 17, and/or other couplings between the turbine 12 and the generator 14.

Keeping the foregoing in mind, the SPG system 10 may include an overspeed protection system 22 to reduce or eliminate overspeed and/or risk of overspeed in the event of a lost electrical load. As further described herein, the overspeed protection system 22 may reduce the differential pressure across the turbine 12, reduce fluid flow rate into the SPG system 10, add a load to the generator 14, or any combination thereof.

In an embodiment, the overspeed protection system 22 may include a bypass line 24 and fast acting devices 26A, 26B. The first fast acting device 26A and/or the second fast acting device 26B may include hydraulic brakes (e.g., closing valve, opening valve, two-way valve, three-way valve, check valve) that control fluid flow along the flow line 18 and/or the bypass line 24. The hydraulic brakes may include ball valves, gate valves, flapper valves, check valves (e.g., one-way valves actuated in response to a pressure exceeding a threshold pressure), or any combination thereof. In certain embodiments, fast acting may correspond to acting or actuating within fractions (e.g., one or more tenths) of a second or with a few seconds (e.g., 1, 2, or 3 seconds) rather than minutes. For example, fast acting may correspond to less than or equal to 1, 2, 3, 4, 5, 6, 7, 8, 9, or 10 seconds or tenths of a second. In certain embodiments, fast acting may correspond to acting or actuating within a time duration less than or equal to 10, 20, 30, 40, or 50 percent of a time duration of actuating the main valves 17 (e.g., 17A, 17B). Within the time duration, the fact acting device 26 may partially close to allow certain fluid flow or completely close to block fluid flow. While the fast acting devices 26A and/or 26B may provide fast acting speed reduction of the turbine 12, the main valves 17 (e.g., 17A, 17B) also may be controlled to close to provide a relative slower flow control through the system. The bypass line 24 may fluidly couple to the flow line 18 both upstream and downstream from the turbine 12, such that the bypass line 24 is configured to divert or bypass fluid flow away from the turbine 12. The fast acting devices 26A, 26B may block fluid flow to the turbine 12 and/or divert fluid flow from the turbine 12. For example, the first fast acting device 26A may be positioned upstream of an inlet of the bypass line 24 and/or the turbine 12. The first fast acting device 26A may include a closing valve that opens to provide fluid along the flow line 18 to the turbine 12 and closes to the block the fluid flow to the flow line 18, the bypass line 24, and the turbine 12. As such, the first fast acting device 26A may block fluid flow to the turbine 12 in the event of load lost. Additionally or alternatively, the first fast acting device 26A may be positioned upstream of at least one filter 21 and/or between a series of filters 21. By blocking fluid flow along the flow line 18, in the event of a load lost, for example, the first fast acting device 26A may reduce damage and/or wear to the filter 21. In other words, the first fast acting device 26 may be reducing the risk of overflow of fluid through the filter 21, which may reduce risk of excessive wear and/or damage to the filter 21.

In another example, the first fast acting device 26A may be positioned downstream of an inlet of the bypass line 24. In such embodiments of the first fast acting device 26A downstream from the inlet, the first fast acting device 26A may be a valve that opens to provide fluid flow to the turbine 12 and closes to block fluid flow to the turbine 12, while the second fast acting device 26B controls fluid flow along the bypass line 24. When closed, the first fast acting device 26A may divert the fluid flow to the bypass line 24, thereby selectively blocking fluid flow to the turbine 12. In certain embodiments, the first fast acting device 26A may only partially close, thereby only partially restricting fluid flow to the turbine 12. Still in another example, the first fast acting device 26A may be positioned at the intersection of the flow line 18 and the bypass line 24, such as at the inlet of the bypass line 24. The first fast acting device 26A may include a three-way valve that opens to a first position to provide fluid flow along the flow line 18 and block fluid flow along the bypass line 24, opens to a second position to block fluid flow along the flow line 18 and provide fluid flow along the bypass line 24, and closes to block fluid flow along the flow line 18 and the bypass line 24.

In certain instances, the first fast acting device 26A and/or the second fast acting device 26B may include an outlet configured to direct fluid flow into the surrounding environment, e.g., the surrounding seawater. For example, the first fast acting device 26A or the second fast acting device 26B may be positioned between the wellhead 23 and the generator 14. An inlet of the first fast acting device 26A or the second fast acting device 26B may couple to the turbine 12 and an outlet of the first fast acting device 26A or the second fast acting device 26B may couple to the wellhead 23. If fluid flow from the turbine 12 increases, the first fast acting device 26A or the second fast acting device 26B may divert the fluid flow into the surrounding seawater and away from the wellhead 23. In this way, the first fast acting device 26A or the second fast acting device 26B may equalize (e.g., pressure balance) the differential pressure on the inlet and outlet.

Additionally or alternatively, the overspeed protection system 22 may include the second fast acting device 26B positioned along the bypass line 24. The second fast acting device 26B may include a closing valve that opens to provide fluid flow along the bypass line 24 and closes to block fluid flow along the bypass line 24, thereby selectively controlling a bypass fluid flow along the bypass line 24 relative to a main fluid flow along the flow line 18 to the turbine 12. In certain instances, the second fast acting device 26B may operate in parallel with the first fast acting device 26A to adjust (e.g., control) the fluid flow along the flow line 18 and/or the bypass line 24. For example, the first fast acting device 26A may be positioned upstream of the inlet of the bypass line 24 and open to provide fluid flow to both the flow line 18 and the bypass line 24. The second fast acting device 26B may close to block fluid flow along the bypass line 24, and as such, the fluid flow may be directed to the turbine 12. In another example, the first fast acting device 26A and the second fast acting device 26B may be partially opened to reduce the amount of fluid flow along the flow line 18 and provide an amount of flow along the bypass line 24 to reduce risk of overspeed of the turbine 12, the generator 14, or both.

In the illustrated example, the first fast acting device 26A and/or the second fast acting device 26B may be activated to open or close based on an amount of fluid flowing into and/or along the flow line 18, a pressure within the flow line 18, or both. For example, if the amount of fluid flow along the flow line 18 meets or exceeds a threshold speed, the first fast acting device 26A may open or close to divert an amount of fluid flow to the bypass line 24. Additionally or alternatively, the second fast acting device 26B may open or close to enable the bypass line 24 to receive a portion of the fluid. In another example, if the pressure within the flow line 18 meets or exceeds a threshold pressure, the first fast acting device 26A and/or the second fast acting device 26B may activate to divert flow fluid onto the bypass line 24, to reduce a speed and/or amount of fluid flowing to the turbine 12. In other instances, the first fast acting device 26A and/or the second fast acting device 26B may activate based on the load applied by the generator 14 being less than a threshold load, a speed and/or frequency of the turbine 12 being greater than or equal to a threshold speed, or both. For example, the first fast acting device 26A and/or the second fast acting device 26B may divert fluid flow onto the bypass line 24 based on the load applied by the generator 14 being less than the threshold load, which may indicate the load lost event. In another example, the first fast acting device 26A and/or the second fast acting device 26B may divert the fluid flow onto the bypass line 24 to reduce a speed and/or frequency of the turbine 12.

In an embodiment, the overspeed protection system 22 may include a load bank (e.g., resistive load bank, inductive load bank, and/or capacitive load bank) and coupled to the generator 14 that exerts a load to the turbine 12 in the event of losing an electrical load (e.g., load associated with pumps, compressors, and/or other equipment powered by the generator 14) in various locations (e.g., subsea, offshore, onshore, etc.). The load bank may be used on topside applications for braking of permanent magnet motors (e.g., the generator 14). For example, the load bank may include resistive elements that may consume the electrical power generated by the generator 14 and exert a load to the turbine 12. The load may cause the turbine 12 to reduce a speed and/or a frequency, thereby reducing or eliminating risk of overspeed. The overspeed protection system 22 may activate the load bank based on grid connection loss, power loss, and/or load loss. As such, the load bank may reduce or eliminate risk of overspeed of the turbine 12, the generator 14, or both in the event of losing an electrical load.

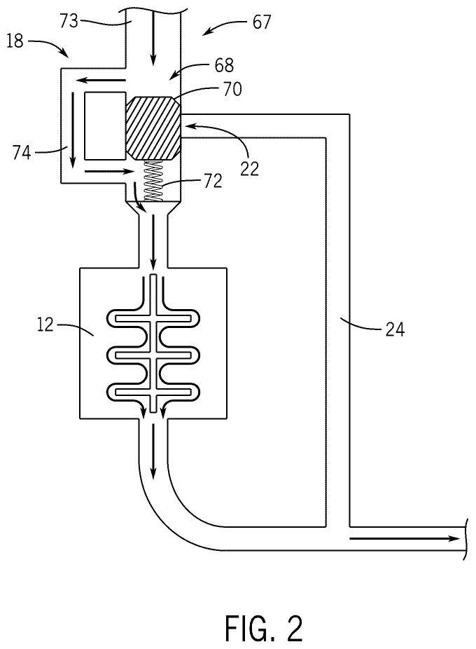

Additionally or alternatively, the overspeed protection system 22 may include coarse water filtration systems, marine growth protection systems for station line internals, vapor protection systems, downstream turbines, valves, or any combination thereof. The coarse water filtration system may include chemical injections or may not include chemical injections. The marine growth protection systems may include an isolation valve located at a station inlet (e.g., between a strainer and filter) to reduce or eliminate ingress of smaller marine life during standstill periods, chemical injections, chemical injections for soak treatments, ultraviolet (UV) light, or any combination thereof. As further described with respect to FIGS. 2-7, the overspeed protection system 22 may include fluid lines, valves, hydraulic brakes, electrical brakes, mechanical brakes, inlet guide vanes, actuators, or any combination thereof to reduce or eliminate risk of overspeed of the turbine 12, the generator 14, or both.

With the foregoing in mind, control and monitoring of the subsea conditions and operations (e.g., operations monitoring for overspeed) may be performed via a control system 28. The control system 28 may include a processor 30 and memory 32. The processor 30 may execute programs, instructions, and/or routines stored in any suitable article of manufacture that includes one or more tangible, non-transitory, computer-readable media. The tangible, non-transitory, computer-readable media may include the memory 32. The memory 32 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 30 to enable the control system 28 perform various functions. For example, the memory 32 may be read-only memory (ROM), random-access memory (RAM), flash memory, an optical storage medium, or a hard disk drive, to name a few examples. Furthermore, the processor 30 may include any suitable computing circuitry such as general-purpose microprocessors, application specific integrated circuits (ASICs), field programmable gate arrays (FPGAs), or any combination thereof. The control system 28 may displayed on a surface platform, at one or more subsea locations, within the SPG system 10, or a combination thereof, among other possibilities.

In certain embodiments, the control system 28 may generate control signals to control and monitor one or more operations of the SPG system 10. The operations may include initiating movements of the turbine 12, initiating operation of the generator 14, and/or the initiating operation of the overspeed protection system 22. For example, the control system 28 may receive sensor signals indicative of a speed of the fluid flow along the flow line 18, a pressure within the flow line 18, a speed and/or frequency of the turbine 12, a load applied by the generator 14, and so on from sensors disposed within the flow line 18, the turbine 12, the generator 14, and so on. The control system 28 may compare the sensor signals to one or more thresholds stored in the memory 32. For example, the control system 28 may compare a speed and/or frequency of the turbine 12 to a stored speed threshold and/or a stored frequency threshold, and identify a condition (e.g., lost load condition or overspeed condition) if the speed and/or frequency exceeds the respective speed threshold and/or frequency threshold. In another example, the control system 28 may compare a speed of the fluid flow to a stored fluid flow speed threshold and/or a pressure of the flow line 18 to a stored pressure threshold, and identify a condition (e.g., lost load condition or overspeed condition) if the flow speed and/or pressure exceeds the respective speed threshold and/or pressure threshold. If the comparison does not identify the condition, then the control system 28 may output control signals to maintain a position (e.g., open position, closed position) of the first fast acting device 26A, the second fast acting device 26B, or both. If the comparison does identify the condition, then the control system 28 may output control signals to adjust a position (e.g., open position, closed position) of the first fast acting device 26A, the second fast acting device 26B, or both, to help reduce or eliminate the condition. Additionally or alternatively, the control system 28 may transmit control signals to enable activation of the load bank in response to the condition identified by the comparison. As further discussed herein, the control system 28 may use the comparison to activate and/or adjust the position of the components of the overspeed protection system discussed below with reference to FIGS. 2-7.

FIG. 2 is a schematic diagram of a portion of the flow line 18 coupled to the SPG system 10 and an embodiment of the overspeed protection system 22 for overspeed protection of the turbine 12. In the illustrated embodiment, the overspeed protection system 22 is driven by pressure differentials in the fluid flow, and thus provides a fast acting hydraulic brake to control the speed of the turbine 12 in the event of a lost load on the generator 14 driven by the turbine 12. The overspeed protection system 22 may include one or more fast acting devices 67, such as a spring-controlled valve 68 formed by a plug 70 (e.g., annular valve plug, piston, or shuttle) and a spring 72 (e.g., coil spring) to control fluid flow along the flow line 18 and the bypass line 24. The spring-controlled valve 68 operates as a one-way valve (e.g., check valve) in response to pressure differential upstream and downstream from the plug 70. The spring-controlled valve 68 operates to gradually respond to changes in the fluid flow and pressure differentials, until a threshold pressure differential is reached to cause actuation between open and closed positions. When the pressure upstream of the plug 70 overcomes the spring 72 and pressure downstream from the plug 70, then the plug 70 moves to compress the spring 72 and open the bypass line 24 (e.g., open position of the plug 70). Otherwise, if the pressure upstream of the plug 70 does not overcome the spring 72 and pressure downstream from the plug 70, then spring 72 expands and biases the plug 70 to close the bypass line 24 (e.g., closed position of the plug 70). The spring-controlled valve 68 may couple to an inlet of the turbine 12 and adjust fluid flow to the turbine 12. The spring-controlled valve 68 may be balanced based on pressure at an inlet of the turbine 12 and a pressure at the outlet of the turbine 12. For example, the spring-controlled valve 68 may partially open the bypass line 24 based on a pressure at the inlet of the turbine 12 increasing and/or partially close the bypass line 24 based on a pressure at the inlet of the turbine 12 decreasing. In another example, if the downstream pressure increases, such as above a threshold pressure), the spring-controlled valve 68 may open the bypass line 24 to divert fluid flow from the turbine 12. The position of the spring-controlled valve 68 may be adjusted based on a differential pressure between the pressure at the inlet and the pressure at the outlet. In general, in response to a lost load on the generator 14, the turbine 12 may speed up, which may cause pressure downstream of the plug 70 to decrease, thereby causing the plug 70 to move from the closed position to the open position to open the bypass line 24 and divert fluid flow onto the bypass line 24.

During operation of the SPG system 10, the fluid flows into the flow line 18 via an inlet 73 of the flow line 18 and along both the flow line 18 and a secondary flow line 74 of the flow line 18 (e.g., main flow line) to the turbine 12. As illustrated, the secondary flow line 74 may fluidly couple to the flow line 18 and divert fluid flow around the spring-controlled valve 68 to the turbine 12. As the fluid flows along the flow line 18, the fluid may exert a pressure on spring-controlled valve 68 both upstream and downstream of the plug 70, which may cause the spring-controlled valve 68 to adjust a position. In the event of a load lost, the pressure at the outlet may significantly decrease, such that the pressure upstream of the plug 70 overcomes the spring 72 and the pressure downstream of the plug 70. Increasing the pressure at the input may cause the position of the plug 70 to shift downstream, or towards the turbine 12. As such, the spring-controlled valve 68 may not block the inlet of the bypass line 24 and divert fluid flow to the bypass line 24 and away from the turbine 12. As the fluid bypasses the turbine 12 via the bypass line 24, the turbine 12 may gradually slow down until the pressure differential enables the plug 70 to move from the open position to the closed position again.

For example, the spring-controlled valve 68 may include the plug 70 positioned at the inlet of the bypass line 24 and the spring 72 positioned at the inlet of the turbine 12. In a fully extended position, the spring 72 may position the plug 70 at the inlet of the bypass line 24. Based on the pressure applied by the fluid, the spring 72 may adjust a position of the plug 70 to adjust the flow of fluid along the flow line 18 and/or the bypass line 24. If the pressure applied by the fluid upstream of the plug 70 (e.g., upstream force due to fluid pressure) is less than a pressure of the fluid downstream of the plug 70 (e.g., downstream force due to fluid pressure) combined with the force of the spring 72, the spring 72 may maintain the position of the plug 70 at the inlet of the bypass line 24 to provide fluid to the turbine 12. If the pressure applied by the fluid upstream of the plug 70 (e.g., upstream force due to fluid pressure) is greater than a pressure of the fluid downstream of the plug 70 (e.g., downstream force due to fluid pressure) combined with the force of the spring 72, the spring 72 may compress and enable movement of the plug 70 to open the inlet of the bypass line 24. In certain embodiments, the spring 72 may gradually compress and gradually move the plug 70 to gradually open the bypass line 24. In general, if the differential fluid pressure overcomes the spring force of the spring 72, the spring 72 may adjust the position of the plug 70 in the downstream direction to divert an amount of fluid flow along the bypass line 24, thereby reducing fluid flow along the flow line 18. For example, the spring 72 may be in a partially compressed position and adjust the position of the plug 70 towards the turbine 12. In certain instances, the pressure applied by the fluid may cause the spring 72 to adjust the position of the plug 70 such that fluid is diverted from the turbine 12 and into the bypass line 24. For example, the spring 72 may be in a fully compressed position and adjust the position of the plug 70 to block the outlet of the secondary flow line 74, thereby blocking fluid flow to the turbine 12. As such, the spring-controlled valve 68 may re-route the fluid flow from turbine 12 in the event of a load lost.

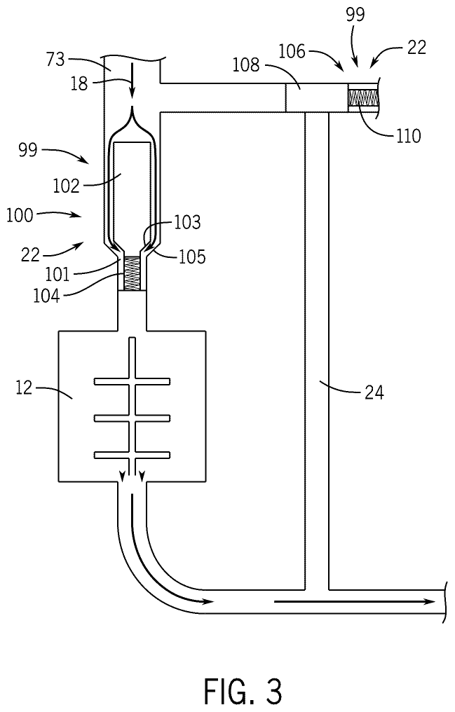

FIG. 3 is a schematic diagram of a portion of the flow line 18 of the SPG system 10 and another embodiment of the overspeed protection system 22 for overspeed protection of the turbine 12. The overspeed protection system 22 may include a plurality of fast acting devices 99, such as a spring-controlled valve 100 formed by a choke plug 102 (e.g., undersized annular plug, piston, or shuttle) and a first spring 104 and a spring-controlled valve 106 formed by a plug 108 (e.g., annular valve plug, piston, or shuttle) and a second spring 110. The spring-controlled valve 100 may be positioned at an inlet of the turbine 12 and the spring-controlled valve 106 may be positioned at an inlet of the bypass line 24. In the illustrated embodiment, the overspeed protection system 22 is driven by pressure differentials in the fluid flow, and thus provides a fast acting hydraulic brake to control the speed of the turbine 12 in the event of a lost load on the generator 14 driven by the turbine 12.

In certain instances, the inlet of the turbine 12 and/or a portion of the flow line 18 match (e.g., substantially) a shape (e.g., profile) of the spring-controlled valve 100. In a fully extended position, the spring-controlled valve 100 may provide fluid flow to the turbine 12. For example, the first spring 104, in the fully extended position (e.g., an open position of the spring-controlled valve 100), may extend the choke plug 102 in an upstream direction and away from the inlet of the turbine 12 to facilitate fluid flow to the turbine 12. For example, the fluid may flow around the choke plug 102 in an annular space 101 between an annular exterior of the choke plug 102 and an annular interior of the flow line 18, and subsequently into the turbine 12. As pressure within the flow line 18 increases upstream from the choke plug 102 and/or decreases downstream from the choke plug 102, the first spring 104 may adjust the position of the choke plug 102 in a downstream direction to decrease the fluid flow to the turbine 12. For example, if a load is lost on the generator 14 driven by the turbine 12, then the turbine 12 may substantially speed up and reduce the pressure downstream of the choke plug 102 and trigger a closure of the choke plug 102. As a result, the pressure applied by the fluid onto the first spring 104 may meet or exceed a threshold pressure of the first spring 104 and compress the first spring 104 in the downstream direction. As such, in a partially compressed position, the first spring 104 may adjust the position of the choke plug 102 in the downstream direction, which may result in a distance between an interior surface of the inlet and the choke plug 102 decreasing and the amount of fluid flowing to the turbine 12 decreasing. In a fully compressed position (e.g., a closed position of the spring-controlled valve 100), the first spring 104 may adjust the position of the choke plug 102 to be flush with the interior surface of the flow line 18, thereby blocking fluid flow to the turbine 12. For example, a tapered annular portion 103 of the choke plug 102 may be pressed against a tapered annular seat 105 in the flow line 18, thereby creating an annular seal to block fluid flow through the flow line 18 to the turbine 12. As such, the spring-controlled valve 100 may adjust the amount of fluid flowing to the turbine 12.

In certain instances, the spring-controlled valve 100 may couple to a quick release device configured to adjust the position of the spring-controlled valve 100. For example, the quick release device may maintain the fully extended position of the choke plug 102 to divert fluid flow onto the bypass line 12. If the electrical load is lost, the quick release device may release the choke plug 102 to adjust the position of the choke plug 102 in the downstream direction and divert fluid flow onto the bypass line 24.

Adjusting the fluid flow along the flow line 18 may cause the fluid to flow towards the bypass line 24 and apply pressure to the spring-controlled valve 106. For example, if the spring-controlled valve 100 is in the closed position, then the fluid may flow towards the bypass line 24 and/or increase pressure on the spring-controlled valve 106. If the pressure applied by the fluid is greater than a pressure threshold to overcome the second spring 110, the second spring 110 may adjust a position of the plug 108 in a downstream direction to enable fluid flow along the bypass line 24. For example, the second spring 110 may adjust the position of the plug 108 such that the inlet of the bypass line 24 is not blocked. If the pressure is less than a pressure threshold to overcome the second spring 110, the second spring 110 may maintain the position of the plug 108 at the inlet of the bypass line 24, thereby blocking fluid flow along the bypass line 24.

The choke plug 102 and the plug 108 may operate together to adjust fluid flow between the flow line 18, the bypass line 24, or both. For example, if the spring-controlled valve 100 is in a partially closed position to block a portion of the fluid flow to the turbine 12, the fluid may apply pressure to the spring-controlled valve 106 and caused the spring-controlled valve 106 to move to a partially closed or partially opened position to enable the portion of fluid to flow along the bypass line 24. As such, the amount of fluid flowing to the turbine 12 may decrease, which may decrease and/or eliminate risk of overspeed of the turbine 12, the generator 14, or both.

To reduce or prevent vacuuming and/or cavitation within the flow line 18, the turbine 12 may stop operations prior to the choke plug 102 reaching a fully closed position. As the turbine 12 slows down, a speed of the fluid along the flow line 18 may also slow down, and the fluid may be diverted to the bypass line 24.

In an embodiment, the overspeed protection system 22 may not include the plug 108. The choke plug 102 may extend in an upstream direction to block fluid flow along the bypass line 24 when pressure within the flow line 18 is less than a bias pressure of the choke plug 102. For example, in the fully extended position, the choke plug 102 may block an inlet of the bypass line 24 such that fluid flows to the turbine 12. The choke plug 102 may include a centerbore to facilitate fluid flow through the center of the choke plug 102 (e.g., into an inlet of the choke plug 102) and out through a side of the choke plug 102. In the fully extended position, the centerbore may align with the inlet of the bypass line 24 to block fluid flow along the bypass line 24. As such, the fluid flows between the choke plug 102 and the flow line 18 towards the turbine 12. If fluid flow increases, a drag may cause the choke plug 102 to transition to a partially compressed position or a fully compressed position, thereby providing fluid flow along the bypass line 24.

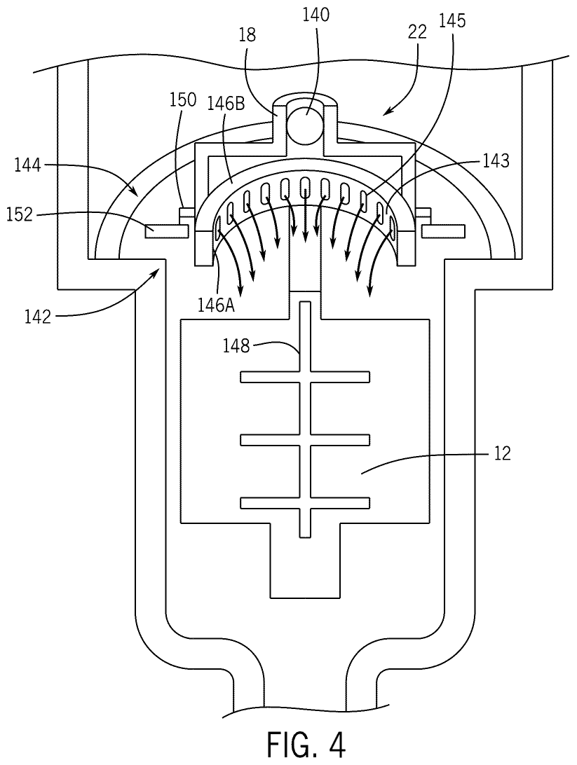

FIG. 4 is a schematic diagram of a portion of the flow line 18 coupled to the SPG system 10 and another embodiment of the overspeed protection system 22 for overspeed protection of the turbine 12. The overspeed protection system 22 may include a centrifugal brake assembly 140 including a guide vane assembly 142 and/or a brake assembly 144 to reduce or eliminate fluid flow to the turbine 12 in the event of a lost load on the generator 14 driven by the turbine 12. The centrifugal brake assembly 140 may be positioned upstream of the turbine 12 and control the fluid flow to the turbine 12 by adjusting a position of the guide vane assembly 142 based on a position of the brake assembly 144 to reduce or eliminate overspeed risk.

The guide vane assembly 142 may include a first guide vane 146A (e.g., annular guide vane) positioned inside of a second guide vane 146B (e.g., annular guide vane). For example, the first and second guide vanes 146A, 146B may be coaxial or concentric annular guide vanes, which are configured to rotate relative to one another to open or close a fluid flow path in a radial direction. In certain instances, the first guide vane 146A may be flush against the second guide vane 146B. The first and second guide vanes 146A, 146B include a plurality of flow guides 143 (e.g., directional vanes, wall portions, or structures) spaced apart from one another circumferentially about a central axis (e.g., in an annular arrangement) of the first and second guide vanes 146A, 146B. Additionally, the first guide vane 146A and the second guide vane 146B may include a plurality of holes 145 (e.g., cut outs, removed portions, openings, or fluid passages) to enable fluid flow through the guide vanes 146A, 146B between the plurality of flow guides 143. In other words, each of the first and second guide vanes 146A, 146B has an alternating arrangement of the plurality of flow guides 143 and the plurality of holes 145. For example, the holes 145 of the first guide vane 146A may overlap with the holes 145 of the second guide vane 146B to direct fluid to the turbine 12 (e.g., an open position of the guide vane assembly 142). In another example, the holes 145 of the first guide vane 146A may misalign with (e.g., not overlap) with the holes 145 of the second guide vane 146B to block fluid to the turbine 12 (e.g., a closed position of the guide vane assembly 142). In particular, the holes 145 of the first guide vane 146A align with the flow guides 143 of the second guide vane 146B to block fluid to the turbine 12 (e.g., a closed position of the guide vane assembly 142). If a speed and/or a frequency of the turbine 12 meets or exceeds a threshold speed and/or a threshold frequency, the centrifugal brake assembly 140 may adjust a position (in a rotational direction) of the first guide vane 146A and/or the second guide vane 146B to misalign the holes, thereby blocking fluid flow through the guide vane assembly 142 and to the turbine 12.

The centrifugal brake assembly 140 may monitor a speed and/or a frequency of the turbine 12 and adjust the position of the guide vane assembly 142 based on the speed. For example, the centrifugal brake assembly 140 may couple to a shaft 148 of the turbine 12 to monitor the speed and/or the frequency of the turbine 12. The brake assembly 144 may include a spring-loaded system that enables one or more brake pads 150 to extend and/or rotate in a radial direction based on a speed of the shaft 148. For example, the faster the shaft 148 may be rotating, the further the one or more brake pads 150 may extend in the radial direction (or rotate from an axial direction to a radial direction) away from the guide vane assembly 142. The brake assembly 144 may include a stationary brake 152 positioned in a radial direction from the one or more brake pads 150. In certain instances, the one or more brake pads 150 extend to a position to couple with the stationary brake 152 based on the speed and/or the frequency of the turbine 12 meeting or exceeding a threshold speed and/or a threshold frequency. In certain embodiments, the one or more brake pads 150 are coupled to the first guide vane 142A (e.g., rotational guide vane), and are engaged with the stationary brake 152 to drive rotation of the first guide vane 142A in a first rotational direction relative to the second guide vane 142B (e.g., stationary guide vane) to actuate the guide vane assembly 142 from an open position to a closed position. Otherwise, when energy is not applied to actuate the brake assembly 144, one or more biasing return actuators (e.g., mechanical spring, hydraulic piston, magnetic actuator, electric actuator, or any combination thereof) may be configured to bias the first guide vane 142A in a second rotational direction relative to the second guide vane 142B to return the guide vane assembly 142 from the closed position to the open position. In certain embodiments, the first guide vane 142A is an outer guide vane disposed about the second guide vane 142B as an inner guide vane, or the first guide vane 142A is an inner guide vane disposed within the second guide vane 142B as an outer guide vane. The rotational movement of the first guide vane 142A may cause misalignment between the holes 145 of the first guide vane 146A and the holes 145 of the second guide vane 146B. As such, the centrifugal brake assembly 140 may block the flow of fluid to the turbine 12, and as such, the speed and/or frequency of the turbine 12 may also be reduced. Additionally or alternatively, the increased friction between the one or more brake pads 150 and the stationary brake 152 may reduce a speed of the shaft 148, which may reduce the speed and/or frequency of the turbine 12.

In an embodiment, the overspeed protection system 22 may include a hydraulic clutch, a governor system, or both in place of the brake assembly 144. The hydraulic clutch and/or the governor system may apply pressure to the guide vane assembly 14 based on a speed of the turbine 12. For example, as the speed of the turbine 12 increases, the hydraulic clutch and/or the governor system may increase pressure applied to the guide vane assembly 14. In certain instances, the pressure may be applied by the hydraulic clutch and/or the governor system may cause the guide vane assembly 14 to close and block fluid flow to the turbine 12, such as in the event of a lost electrical load.

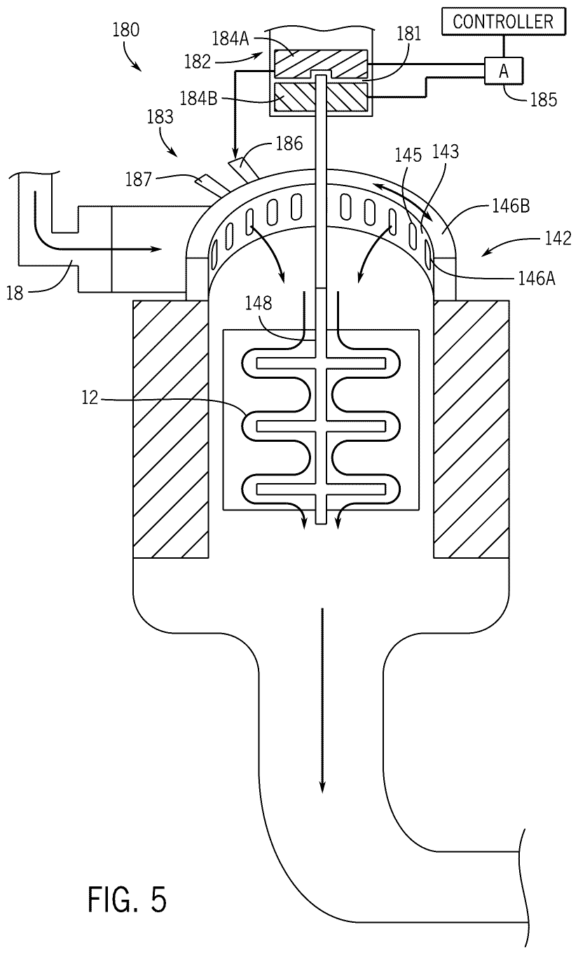

FIG. 5 is a schematic diagram of a portion of the flow line 18 of the SPG system 10 and the overspeed protection system 22 for overspeed protection. The overspeed protection system 22 may include a hydraulic disc brake assembly 180 formed by a turbine-to-turbine system 182, a guide vane assembly 142, and a brake assembly 183. The turbine-to-turbine system 182 may couple to the shaft 148 of the turbine 12, wherein the turbine-to-turbine system 182 includes a first turbine 184A (e.g., hydraulic rotor or disc) separate from the shaft 148 and a second turbine 184B (e.g., hydraulic rotor or disc) coupled to the shaft 148. The first and second turbines 184A and 184B may operate in a variety of ways to provide hydraulic braking of the shaft 148 of the turbine 12 to provide overspeed protection, such as in response to a speed and/or a frequency of the shaft 148 and the turbine 12 meeting or exceeding a threshold speed and/or a threshold frequency. For example, the first and second turbines 184A and 184B may be opposing turbines, where either the first turbine 184A or the second turbine 184B may increase in speed such that it causes the guide vane assembly 142 to close and block fluid flow to the turbine 12. In another example, the turbine-to-turbine system 182 may provide electrical energy to a generator and/or a load bank. The generator may couple to the turbine-to-turbine system 182 and generate electrical power during operation of the turbine-to-turbine system 182. The generator may transmit the electrical power to the load bank for operations. For example, the load bank may couple to the guide vane assembly 142 and provide braking power to the guide vane assembly 142. The load bank may be configured to adjust the position of the guide vane assembly 142 to a closed position to block fluid flow to the turbine 12 and maintain the guide vane assembly 142 in the closed position.

In certain embodiments, each of the first and second turbines 184A and 184B includes a shaft coupled to a rotor having a plurality of turbine blades configured to rotate within a fluid chamber. The first and second turbines 184A and 184B may be selectively actuated to rotate with shaft 148 of the turbine 12 to create a load or resistance to rotation of the shaft 148, as the plurality of turbine blades of the first and second turbines 184A and 184B rotate with the fluid chamber. In other words, instead of being driven to rotate by a fluid flow, the first and second turbines 184A and 184B are subject to a fluid (e.g., static fluid) that creates a drag or resistance to rotation of the first and second turbines 184A and 184B. In some embodiments, the first and second turbines 184A and 184B are selectively coupled to the shaft 148 via a clutch or other torque transfer interface. In some embodiments, the second turbine 184B is coupled to the shaft 148 while the first turbine 184A is decoupled from the shaft 148, such that fluid between the first and second turbines 184A and 184B creates a drag on rotation of the second turbine 184B and the shaft 148. In some embodiments, at least one of the first and second turbines 184A and 184B is coupled to the brake assembly 183 to enable actuation of the brake assembly 183 for actuation of the guide vane assembly 142 between open and closed positions.

In certain embodiments, the first and second turbines 184A and 184B are normally spaced apart from one another by an axial spacing 181 when not actuated to provide braking. However, the first and second turbines 184A may be actuated via an actuator 185 to eliminate the axial spacing 181 and contact one another to provide braking for overspeed protection. In certain embodiments, the first turbine 184A is actuated to move in an axial direction between an engaged position and a disengaged position relative to the second turbine 184B, wherein rotational motion of the second turbine 184B is transferred onto an engagement surface with the first turbine 184A in the engaged position. In certain embodiments, the first turbine 184A is not rotatable and thus the rotational motion of the second turbine 184B slows down in response to friction along the engagement surface. In certain embodiments, the first turbine 184A includes a plurality of turbine blades coupled to a rotor or disc within a fluid chamber, such that the rotational motion of the second turbine 184B transfers rotational motion to the first turbine 184A via the engagement surface and the plurality of turbine blades impart a load on the shaft 148 as the turbine blades resist rotation within the fluid chamber. Additionally, in certain embodiments, the first turbine 184A may be coupled to the brake assembly 183 to impart mechanical energy (e.g., rotational motion) to actuate the brake assembly 183.

The turbine-to-turbine system 182 may be actuated to provide braking to the shaft 148 of the turbine 12 and, if the speed and/or the frequency of the turbine 12 meets or exceeds a threshold speed and/or threshold frequency, the turbine-to-turbine system 182 may apply a load to the turbine 12, and/or adjust a position of the guide vane assembly 142 to reduce fluid flow to the turbine 12 and/or adjust operation of the turbine 12. For example, applying the load to the turbine 12 via the turbine-to-turbine system 182 may decrease the speed and/or the frequency of the turbine 12. In another example, the turbine-to-turbine system 182 and/or the control system 28 may instruct a reduced operation and/or shut down of the turbine 12. In some embodiments, the turbine-to-turbine system 182 generates mechanical energy and/or electrical energy to actuate the brake assembly 183.

The position of the guide vane assembly 142 may be based on the speed and/or the frequency of the turbine 12. If the speed and/or frequency of the turbine 12 is less than a threshold speed and/or threshold frequency, then the holes 145 of the first guide vane 142A may align with the holes 145 of the second guide vane 142B, and thus, fluid may flow to the turbine 12. If the speed and/or frequency of the turbine 12 is equal to or greater than a threshold speed and/or threshold frequency, then the holes 145 of the first guide vane 142A may misalign with the holes 145 (and instead align with the flow guides 143) of the second guide vane 142B, thereby blocking fluid flow to the turbine 12.

The turbine-to-turbine system 182 may provide electrical and/or mechanical energy to the brake assembly 183 to adjust the position of the guide vane assembly 142. The brake assembly 183 may include a lock-up brake 186 that may move an amount in a rotational direction relative to a stopper 187 in response to energy provided by the turbine-to-turbine system 182. The amount of movement may be determined by specifications of the lock-up brake 186, the control system 28, a user, or any combination thereof. The brake assembly 183 may couple to the guide vane assembly 142 and adjust a position of the guide vane assembly 142 based on movement in the rotational direction. In certain embodiments, the lock-up brake 186 of the brake assembly 183 is coupled to, and is engaged to drive rotational movement of, the first guide vane 142A (e.g., rotational guide vane) in a first rotational direction relative to the second guide vane 142B (e.g., stationary guide vane) to actuate the guide vane assembly 142 from an open position to a closed position. Otherwise, when energy is not applied to actuate the brake assembly 183, one or more biasing return actuators (e.g., mechanical spring, hydraulic piston, magnetic actuator, an electric actuator, or any combination thereof) may be coupled to the lock-up brake 186 of the brake assembly 183 to bias the first guide vane 142A in a second rotational direction relative to the second guide vane 142B to return the guide vane assembly 142 from the closed position to the open position. In certain embodiments, the first guide vane 142A is an outer guide vane disposed about the second guide vane 142B as an inner guide vane, or the first guide vane 142A is an inner guide vane disposed within the second guide vane 142B as an outer guide vane. In operation, the guide vane assembly 142 and the brake assembly 183 may be in an open position to facilitate fluid flow through the guide vane assembly 142. If the lock-up brake 186 moves in a first rotational direction, the lock-up brake 186 may cause the guide vane assembly 143 to shift into the closed position to block fluid flow. If the lock-up brake 186 moves in a second rotational direction opposite the first rotational direction, the lock-up brake 186 may cause the guide vane assembly 143 to shift back into the open position. In certain embodiments, the control system 28 may transmit a control signal to the brake assembly 183 indicative of adjusting the position of the guide vane assembly 143 based on the speed and/or the frequency of the turbine 12.

The hydraulic disc brake assembly 180 may use the lock-up brake 186 and the turbine-to-turbine system 182 to reduce and/or eliminate risk of overspeed of the turbine 12. In certain instances, the turbine-to-turbine system 182 may include a slip function to prevent a hard stop by the lock-up brake 186 when engaged. The turbine-to-turbine system 182 may provide for slippage when a speed and/or frequency of the turbine 12 meets or exceeds a torque threshold to reduce the speed and/or the frequency of the turbine 12 over a period of time, thereby reducing wear and/or friction of the lock-up brake 186. In other embodiments, the lock-up brake 186 may engage with the guide vane assembly 142 and an electromechanical retarder to facilitate braking of the shaft 148 and allow the shaft 148 to continue movement after the guide vane assembly 142 is moved to the closed position and provide a minimum amount of fluid flow to the turbine 12. In other words, the lock-up brake 186 and the electromechanical retarder may divert a portion of the fluid from the turbine 12 and provide a remaining portion of the fluid to the turbine 12 to reduce the speed and/or frequency of the turbine 12 over a period of time. As the amount of fluid flowing to the turbine 12 decreases, the speed and/or the frequency of the turbine 12 may decrease. Additionally or alternatively, the hydraulic disc brake assembly 180 may include a positional lock that maintains the guide vane assembly 142 in the closed position until the SPG system 10 is reset (e.g., by the control system 28) to reduce or eliminate risk of overspeed of the turbine 12, the generator 14, or both. In certain embodiments, a spring loaded or return system may be coupled to the guide vane assembly 142 to adjust the position of the guide vane assembly 142 between the open position and the closed position. In certain instances, an actuator may be coupled to and/or adjusts the position of the guide vane assembly 142.

In an embodiment, the hydraulic disc brake assembly 180 as described in FIG. 5 may be controlled by the control system 28 and/or the actuator 185. In other embodiments, the guide vane assembly 142 of FIG. 5 may be spring loaded or equipped with other return mechanisms to adjust between the closed position and the open position.

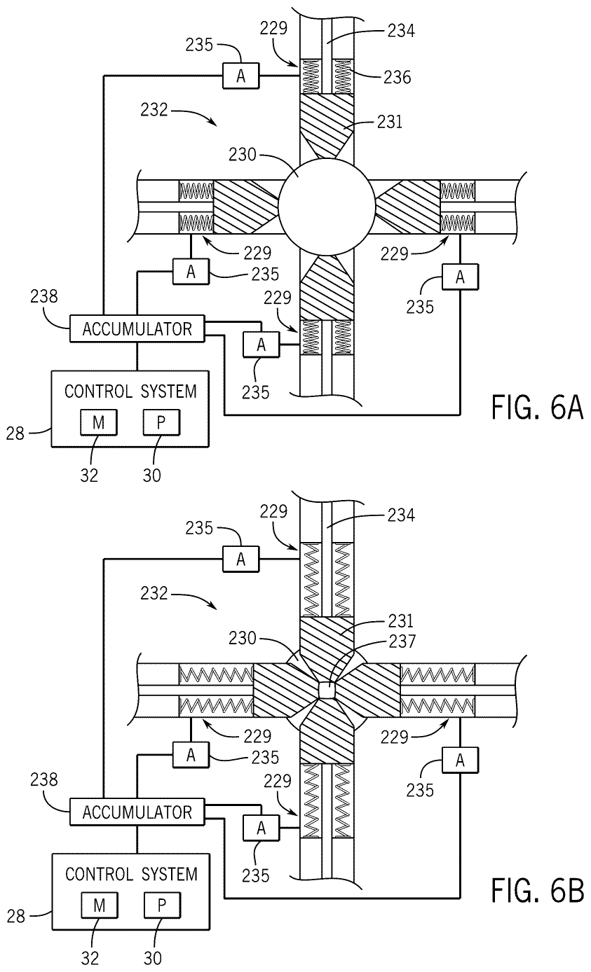

FIGS. 6A and 6B illustrates a top down cross-sectional view of an inlet 230 of the turbine 12 of the SPG system 10 coupled to the overspeed protection system 22. For example, FIG. 6A is a top down cross-sectional view of an embodiment of a fast acting device 232 (e.g., flow control valve) of the overspeed protection system 22 in an open position and FIG. 6B is a top down cross-sectional view of the fast acting device 232 of the overspeed protection system 22 in a closed position. In certain embodiments, the fast acting device 232 may be used for the fast acting devices 26A, 26B of FIG. 1, the fast acting device 67 of FIG. 2, the fast acting devices 99 of FIG. 3, or any combination thereof. In certain embodiments, the fast acting device 232 may be used in combination with the guide vane assembly 142 of FIGS. 4 and 5. The fast acting device 232 may be positioned within the flow line 18 and couple to the inlet of the turbine 12. In the open position, as illustrated in FIG. 6A, the fast acting device 232 may provide fluid flow to the turbine 12. In the closed position, as illustrated in FIG. 6B, the fast acting device 232 may close to block fluid flow to the turbine 12. In certain instances, the fast acting device 232 may be in a partially open position to reduce the amount of fluid flowing to the turbine 12. To facilitate discussion, FIGS. 6A and 6B are discussed together below.

The fast acting device 232 may include a plurality of radial valve portions 229 configured to move in a radial direction between an extended position within the inlet 230 (e.g., closed valve position) and a retracted position out of the inlet 230 (e.g., open valve position). Each of the plurality of radial valve portions 229 includes a valve head 231 (e.g., valve element, plug, tip, or piston) coupled to a valve shaft or stem 234, wherein a spring 236 is disposed about the stem 234 and biases the valve head 231 away from a support bushing 233 and toward the inlet 230. In the illustrated embodiment, each of the radial valve portions 229 has an actuator 235 coupled to the stem 234, wherein the actuator 235 is configured to actuate the fast acting device 232 to move the valve head 231 within a radial bore 237 (e.g., annular bore). As illustrated, the fast acting devices 232 includes a plurality of radial bores 237 intersecting the inlet 230, thereby supporting a plurality of the radial valve portions 229. In certain embodiment, the actuator 235 is configured to release the stem 234 to be driven by the spring 236 and/or drive movement of the stem 234 to move the valve head 231 into the inlet 230. In certain embodiment, the actuator 235 is configured to drive movement of the stem 234 (e.g., retract the stem 234 against the spring 236) when resetting or moving the fast acting device 232 from the closed position to an open position. The actuator 235 may include an electric actuator, a fluid actuator (e.g., pneumatic or hydraulic actuator) having a piston-cylinder assembly, or any combination thereof. When using a fluid actuator, the actuator 235 may be coupled to an accumulator 238 configured to store fluid pressure to enable fast operation of the actuator 235.

The fast acting device 232 is configured to extend the valve heads 231 into the inlet flow stream and reduce the cross section of the flow line 18 and reduce fluid flow, in the closed position. For example, the fast acting device 232 may include four valve heads 231 that couple together in the closed position to block fluid flow to the turbine 12. It may be appreciated that the fast acting device 232 may include any suitable number of valve heads 231, such as three valve heads, five valve heads, and so on, that couple together in the closed position.

In certain embodiments, the actuator 235 and/or the spring 236 of the fast acting device 232 may actuate the radial valve portions 229 (e.g., valve heads 231) based on the speed and/or frequency of the turbine 12 meeting or exceed a threshold speed and/or threshold frequency to adjust the position of the valve heads 231 in a radial direction towards the center of the inlet 230. As such, the actuator 235 and/or the spring 236 may adjust the position of the valve head 231 into the inlet flow stream to block the fluid flow to the turbine 12. In certain embodiments, the valve heads 231 may be spring loaded with the springs 236 while the actuators 235 operate as quick release trigger devices. In certain instances, the actuators 235 may adjust the position of the valve heads 231 in the radial direction to block only a portion or all of the fluid flow. Blocking a portion of the fluid flow may create turbulence at the inlet of the turbine 12, which may reduce a speed and/or frequency of the turbine 12. For example, extending the valve heads 231 into the fluid flow may increase turbulence that may reduce the power intensity of the fluid flow into the turbine 12. In an embodiment, the control system 28 may transmit a control signal to the actuator 235 indicative of adjusting the position of the radial valve portions 229 based on the speed and/or frequency of the turbine 12.

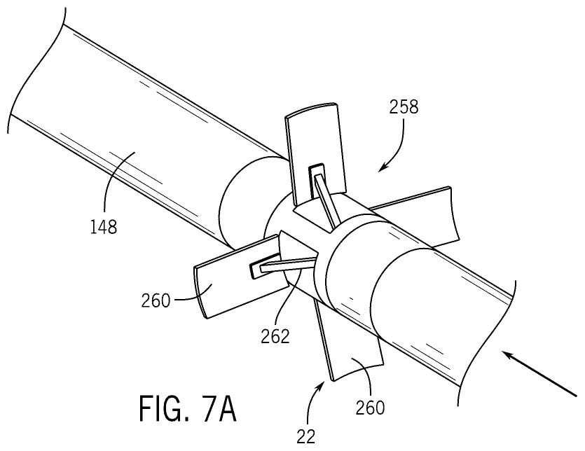

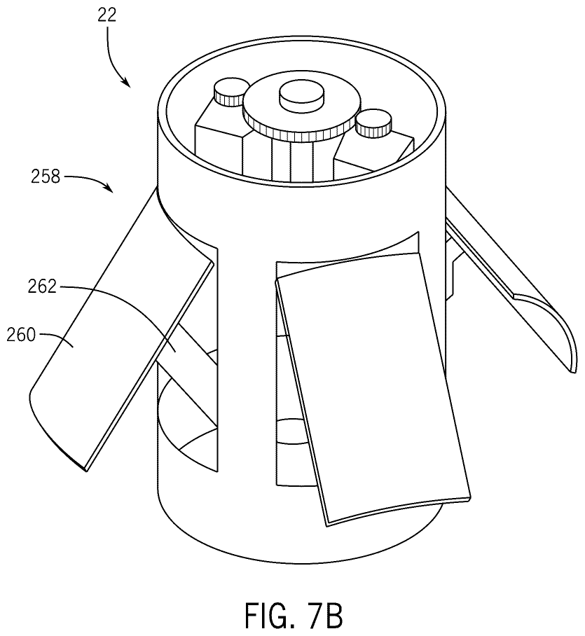

FIG. 7A is a schematic diagram of a portion of the flow line 18 coupled to the SPG system 10 with another embodiment of the overspeed protection system 22 having a fast-acting device 258 (e.g., spring-loaded drag brakes) for overspeed protection of the turbine 12, the generator 14, or both. FIG. 7B is a partial cutaway view of the overspeed protection system 22 of FIG. 7A. In certain embodiments, the fast acting device 258 may be used for the fast acting devices 26A, 26B of FIG. 1, the fast acting device 67 of FIG. 2, the fast acting devices 99 of FIG. 3, or any combination thereof. In certain embodiments, the fast-acting device 258 may be used in combination with the guide vane assembly 142 of FIGS. 4 and 5. To facilitate discussion, FIGS. 7A and 7B are discussed together below.

The fast acting device 258 may include one or more arms 260 coupled to the shaft 148 of the turbine 12 that expand in a radial direction as a speed and/or a frequency of the turbine 12 increases. The arms 260 are configured to reduce a rotational speed of the turbine 12 by impeding rotation of the shaft 148. Accordingly, the arms 260 may include a variety of shapes and orientations to control a rotational resistance of the shaft 148 within a fluid flow. In certain embodiments, the arms 260 include flat panels or curved panels (e.g., C-shaped panels or semi-cylindrical panels). The arms 260 also may partially turn or rotate against the rotational direction of the shaft 148. The arms 260 may be coupled to spring-loaded shafts (e.g., spring 262) that may also be coupled to the shaft 148 to cause the arms 260 to move in a radial direction based on a speed and/or a frequency of the turbine 12 meeting or exceed a speed threshold or a frequency threshold. The fast acting device 258 may be positioned within the turbine 12 and/or upstream of the inlet of the turbine 12.

In certain instances, the arms 260 may include spring-loaded drag brakes that may be flush against the shaft 148 in a retracted position and extend outwardly into the flow line 18 in an extended position. In the retracted position, the spring 262 may position the arms 260 flush with the shaft 148, and as such, fluid may flow within the turbine 12 without disturbances and/or to the turbine 12. When the speed and/or frequency of the turbine 12 meets or exceeds a threshold speed and/or threshold frequency, the arms 260 may extend in a radial direction as illustrated by FIG. 7A. The threshold speed and/or threshold frequency may correspond to speed and/or frequency associated with turbine 12 overspeed, generator 14 overspeed, or both. In other embodiments, the arms 260 may extend if a centrifugal force meets or exceeds a threshold centrifugal force associated with turbine overspeed protection, generator overspeed protection, or both. The arms 260 may extend in a direction opposite of fluid flow, which may facilitate extension of the arms 260 and maintain the arms 260 in the open position. Since the arms 260 extend within the flow line 18, the flow area may be reduced, and the speed of the fluid flow may be reduced by the arms 260. In the extended position, the arms 260 may engage into the flow path (e.g., within the turbine 12) to increase turbulence and/or reduce a rotational speed of the turbine 12.

In certain embodiments, as illustrated in FIG. 7A, the arms 260 may be positioned proximate to the inlet of the turbine 12 and engaged with the flow line 18 in the extended position. In the extended position, the twisting vane assembly (e.g., the arms 260) may reduce flow area, thereby reducing fluid flow to the turbine 12. Additionally or alternatively, the twisting vane assembly may also move in a rotational direction, such as in a twisting motion, to increase turbulence of the fluid upstream of the turbine 12. In response to a reduction in the centrifugal force and the amount of fluid flow, the arms 260 may return to the retracted position, as illustrated by FIG. 7B.

In an embodiment, the arms 260 may create a fluid force exerted on another initially stationary turbine (e.g., the first turbine 184A of the turbine-to-turbine system 182, the second turbine 184B of the turbine-to-turbine system 182) coupled to the guide vane assembly 142. When the arms 260 are fully extended, the arms 260 may catch fluid that may exert a force on the guide vane assembly 142 and cause the guide vane assembly 142 to adjust to a closed position. As such, the fluid flow to the turbine 12 may be blocked.

Technical effects of the disclosed embodiments include systems and methods for reducing risk of overspeed in turbines, generators, or both of subsea power generation systems in the event of a lost load. The disclosed embodiments may reduce risk of overspeed by reducing a differential pressure across the turbine, reducing flow rate into the turbine, adding a load to the generator, or any combination thereof. For example, the disclosed embodiments may include hydraulic brakes that block fluid flow to the turbine, divert fluid flow from the turbine to a bypass line, or both. In another example, the disclosed embodiments may include electrical brakes to apply a load to the turbine in the event of a lost load. Still in another example, the disclosed embodiments may include a centrifugal brake system including a guide vane assembly and a brake assembly to adjust the amount of fluid provided to the turbine based on a speed and/or a frequency of the turbine. In other embodiments, a turbine-to-turbine system may couple to a guide vane assembly and a brake assembly to adjust the amount of fluid provided to the turbine. The disclosed embodiments may also include one or more arms coupled to a shaft of the turbine that extends to increase turbulence of the fluid, decrease speed of the turbine, and/or decrease frequency of the turbine. The disclosed embodiments may also include an inlet vane assembly to adjust the cross sectional area of the inlet of the turbine, thereby adjusting the amount of fluid provided to the turbine. For example, the inlet vane assembly may reduce the cross sectional area of the inlet based on detecting overspeed of the turbine, overspeed of the generator, and/or a lost electrical load. As such, the disclosed embodiments may reduce or eliminate risk of overspeed by implementing an overspeed protection system.

In an embodiment, a system may include a subsea power generation system including a turbine configured to couple to a flow line, wherein the turbine is configured to generate mechanical power using flow of a fluid through the turbine, a generator coupled to the turbine, wherein the generator is configured to apply a load to the turbine based on generating electrical power using the mechanical power from the turbine, and an overspeed protection system configured to reduce or eliminate overspeed of the turbine or the generator based on a loss of an electrical load.

The system of the preceding clause, wherein the overspeed protection system includes a bypass line fluidly coupled to the flow line and configured to divert at least a portion of the fluid away from the turbine and a hydraulic brake assembly configured to block the fluid from flowing to the turbine and divert at least the portion of the fluid to the bypass line.

The system of the preceding clause, wherein the hydraulic brake assembly comprises at least one spring-loaded plug.

The system of the preceding clause, wherein the at least one spring-loaded plug comprises a first spring-loaded plug along the flow line.

The system of the preceding clause, wherein the at least one spring-loaded plug comprises a second spring-loaded plug along the bypass line.

The system of the preceding clause, wherein the first spring-loaded plug is disposed at an intersection of the flow line and the bypass line.

The system of any preceding clause, wherein the overspeed protection system comprises a centrifugal brake assembly coupled to a shaft of the turbine, wherein the centrifugal brake assembly is configured to provide the fluid to the turbine in an open position of the centrifugal brake assembly based on a speed of the turbine being less than a threshold speed and block at least a portion of the fluid to the turbine in a closed position of the centrifugal brake assembly based on the speed of the turbine meeting or exceeding the threshold speed.

The system of the preceding clause, wherein the centrifugal brake assembly comprises a guide vane assembly coupled to the shaft of the turbine and configured to provide the fluid to the turbine in the open position and block fluid to the turbine in the closed position and a brake assembly coupled to the guide vane assembly and comprising one or more brake pads and a stationary brake, wherein the brake assembly is configured to adjust the guide vane assembly between the open position and the closed position based on the speed of the turbine, wherein the one or more brake pads are configured to extend in a radial direction to engage the stationary brake based on the speed of the turbine.

The system of the preceding clause, wherein the brake assembly is configured to adjust a position of the guide vane assembly to the closed position based on the speed of the turbine meeting or exceeding the threshold speed.

The system of any preceding clause, wherein the overspeed protection system comprises a valve disposed within the flow line and coupled to an inlet of the turbine, wherein the valve comprises a plurality of radial valve portions configured to extend radially into the flow line toward one another and block at least a portion of the fluid from the turbine.

The system of any preceding clause, wherein the overspeed protection system comprises a spring-loaded drag brake coupled to a shaft of the turbine along a fluid flow path of the fluid, wherein the spring-loaded drag brake is configured to move between a retracted position along the shaft and an extended position protruding from the shaft.

In an embodiment, a system may include a flow line configured to provide a fluid to a well, wherein the fluid comprises water from a subsea environment having a hydrostatic pressure greater than a reservoir pressure in the well and a subsea power generation system coupled to the flow line, where the subsea power generation system is configured to fill the well with the fluid based a pressure differential between the hydrostatic pressure and the reservoir pressure. The subsea power generation system may include a turbine configured to generate mechanical power based on a flow of the fluid through the turbine, a generator coupled to the turbine, wherein the generator is configured to generate electrical power based on the mechanical power from the turbine, and an overspeed protection system configured to adjust an amount of the fluid provided to the turbine.

The system of the preceding clause, including a bypass line fluidly coupled to the flow line and configured to divert at least a portion of the fluid away from the turbine and a hydraulic brake assembly configured to block the fluid from flowing to the turbine and divert at least the portion of the fluid to the bypass line.

The system of any preceding clause, including a control system configured to adjust the overspeed protection system from an open position to a closed position based on determining that a speed of the turbine meets or exceeds a threshold speed or determining that a centrifugal force of the turbine meets or exceeds a threshold centrifugal force.

The system of the preceding clause, wherein the overspeed protection system comprises a guide vane assembly, a centrifugal brake, a hydraulic disc brake, a drag brake, or a combination thereof, coupled to the turbine.

In an embodiment, a system may include a subsea power generation system including a turbine configured to generate mechanical power based movement of a fluid through the turbine and an overspeed protection system coupled to the turbine and configured to adjust an amount of fluid provided to the turbine based on a speed of the turbine.

The system of the preceding clause, wherein the overspeed protection system comprises a guide vane assembly coupled to a shaft of the turbine upstream of an inlet of the turbine, wherein the guide vane assembly is configured to provide the fluid to the turbine in an open position and block the fluid from the turbine in a closed position and a turbine-to-turbine system coupled to and the guide vane assembly, wherein the turbine-to-turbine system is configured to adjust a position of the guide vane assembly to the closed position based on the speed of the shaft meeting or exceeding a threshold speed.

The system of any preceding clause, wherein the overspeed protection system comprises a guide vane assembly coupled to a shaft of the turbine and positioned upstream of the turbine, wherein the guide vane assembly is configured to provide the fluid to the turbine in an open position and block fluid from the turbine in a closed position and a brake assembly coupled to the guide vane assembly and comprising one or more brake pads and a stationary brake, wherein the brake assembly is configured to adjust the guide vane assembly between the open position and the closed position based on the speed of the shaft, and wherein the one or more brake pads are configured to extend in a radial direction to engage the stationary brake based on the speed of the shaft.

The system of any preceding clause, including a control system configured to adjust the overspeed protection system from an open position to a closed position based on the speed of the turbine or a centrifugal force of the turbine.

The system of the preceding clause, wherein the control system is configured to actuate the overspeed protection system in response to a lost electrical load while the fluid is flowing through the turbine from a subsea environment into a well, wherein the fluid comprises water from the subsea environment having a hydrostatic pressure greater than a pressure in the well.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. § 112(f). However, for any claims containing elements designated in any other manner, it is intended that such elements are not to be interpreted under 35 U.S.C. § 112(f).

1. A system comprising:
a subsea power generation system, comprising:
a turbine configured to couple to a flow line, wherein the turbine is configured to generate mechanical power using flow of a fluid through the turbine;
a generator coupled to the turbine, wherein the generator is configured to apply a load to the turbine based on generating electrical power using the mechanical power from the turbine; and
an overspeed protection system configured to reduce or eliminate overspeed of the turbine or the generator based on a loss of an electrical load.

2. The system of claim 1, wherein the overspeed protection system comprises:
a bypass line fluidly coupled to the flow line and configured to divert at least a portion of the fluid away from the turbine; and
a hydraulic brake assembly configured to block the fluid from flowing to the turbine and divert at least the portion of the fluid to the bypass line.

3. The system of claim 2, wherein the hydraulic brake assembly comprises at least one spring-loaded plug.

4. The system of claim 3, wherein the at least one spring-loaded plug comprises a first spring-loaded plug along the flow line.

5. The system of claim 4, wherein the at least one spring-loaded plug comprises a second spring-loaded plug along the bypass line.

6. The system of claim 4, wherein the first spring-loaded plug is disposed at an intersection of the flow line and the bypass line.

7. The system of claim 1, wherein the overspeed protection system comprises a centrifugal brake assembly coupled to a shaft of the turbine, wherein the centrifugal brake assembly is configured to:
provide the fluid to the turbine in an open position of the centrifugal brake assembly based on a speed of the turbine being less than a threshold speed; and
block at least a portion of the fluid to the turbine in a closed position of the centrifugal brake assembly based on the speed of the turbine meeting or exceeding the threshold speed.

8. The system of claim 7, wherein the centrifugal brake assembly comprises:
a guide vane assembly coupled to the shaft of the turbine and configured to provide the fluid to the turbine in the open position and block fluid to the turbine in the closed position; and
a brake assembly coupled to the guide vane assembly and comprising one or more brake pads and a stationary brake, wherein the brake assembly is configured to adjust the guide vane assembly between the open position and the closed position based on the speed of the turbine, wherein the one or more brake pads are configured to extend in a radial direction to engage the stationary brake based on the speed of the turbine.

9. The system of claim 8, wherein the brake assembly is configured to adjust a position of the guide vane assembly to the closed position based on the speed of the turbine meeting or exceeding the threshold speed.

10. The system of claim 1, wherein the overspeed protection system comprises a valve disposed within the flow line and coupled to an inlet of the turbine, wherein the valve comprises a plurality of radial valve portions configured to extend radially into the flow line toward one another and block at least a portion of the fluid from the turbine.

11. The system of claim 1, wherein the overspeed protection system comprises a spring-loaded drag brake coupled to a shaft of the turbine along a fluid flow path of the fluid, wherein the spring-loaded drag brake is configured to move between a retracted position along the shaft and an extended position protruding from the shaft.

12. A system comprising:
a flow line configured to provide a fluid to a well, wherein the fluid comprises water from a subsea environment having a hydrostatic pressure greater than a reservoir pressure in the well; and
a subsea power generation system coupled to the flow line, wherein the subsea power generation system is configured to fill the well with the fluid based a pressure differential between the hydrostatic pressure and the reservoir pressure, wherein the subsea power generation system comprises:
a turbine configured to generate mechanical power based on a flow of the fluid through the turbine;
a generator coupled to the turbine, wherein the generator is configured to generate electrical power based on the mechanical power from the turbine; and
an overspeed protection system configured to adjust an amount of the fluid provided to the turbine.

13. The system of claim 12, comprising:
a bypass line fluidly coupled to the flow line and configured to divert at least a portion of the fluid away from the turbine; and
a hydraulic brake assembly configured to block the fluid from flowing to the turbine and divert at least the portion of the fluid to the bypass line.

14. The system of claim 12, comprising a control system configured to adjust the overspeed protection system from an open position to a closed position based on determining that a speed of the turbine meets or exceeds a threshold speed or determining that a centrifugal force of the turbine meets or exceeds a threshold centrifugal force.

15. The system of claim 14, wherein the overspeed protection system comprises a guide vane assembly, a centrifugal brake, a hydraulic disc brake, a drag brake, or a combination thereof, coupled to the turbine.

16. A system comprising:
a subsea power generation system, comprising:
a turbine configured to generate mechanical power based movement of a fluid through the turbine; and
an overspeed protection system coupled to the turbine and configured to adjust an amount of fluid provided to the turbine based on a speed of the turbine.

17. The system of claim 16, wherein the overspeed protection system comprises:
a guide vane assembly coupled to a shaft of the turbine upstream of an inlet of the turbine, wherein the guide vane assembly is configured to provide the fluid to the turbine in an open position and block the fluid from the turbine in a closed position; and
a turbine-to-turbine system coupled to and the guide vane assembly, wherein the turbine-to-turbine system is configured to adjust a position of the guide vane assembly to the closed position based on the speed of the shaft meeting or exceeding a threshold speed.

18. The system of claim 16, wherein the overspeed protection system comprises:
a guide vane assembly coupled to a shaft of the turbine and positioned upstream of the turbine, wherein the guide vane assembly is configured to provide the fluid to the turbine in an open position and block fluid from the turbine in a closed position; and
a brake assembly coupled to the guide vane assembly and comprising one or more brake pads and a stationary brake, wherein the brake assembly is configured to adjust the guide vane assembly between the open position and the closed position based on the speed of the shaft, and wherein the one or more brake pads are configured to extend in a radial direction to engage the stationary brake based on the speed of the shaft.

19. The system of claim 16, comprising a control system configured to adjust the overspeed protection system from an open position to a closed position based on the speed of the turbine or a centrifugal force of the turbine.

20. The system of claim 19, wherein the control system is configured to actuate the overspeed protection system in response to a lost electrical load while the fluid is flowing through the turbine from a subsea environment into a well, wherein the fluid comprises water from the subsea environment having a hydrostatic pressure greater than a pressure in the well.
